(19) United States
(12) Patent Application Publication
(10) Pub. No.: US 2013/0098660 A1
(43) Pub. Date: Apr. 25, 2013

(54) ELECTRIC WIRE PROTECTION STRUCTURE AND METHOD FOR MANUFACTURING ELECTRIC WIRE PROTECTION STRUCTURE

(71) Applicants: Shinichi Igarashi, Yokkaichi-city (JP); Nobumasa Takihara, Yokkaichi-city (JP); Yukihiro Shirafuji, Yokkaichi-city (JP); Atsushi Murata, Yokkaichi-city (JP); Osamu Satou, Yokkaichi-city (JP); Satoshi Tanigawa, Yokkaichi-city (JP); Masamichi Yamagiwa, Yokkaichi-city (JP)

(72) Inventors: Shinichi Igarashi, Yokkaichi-city (JP); Nobumasa Takihara, Yokkaichi-city (JP); Yukihiro Shirafuji, Yokkaichi-city (JP); Atsushi Murata, Yokkaichi-city (JP); Osamu Satou, Yokkaichi-city (JP); Satoshi Tanigawa, Yokkaichi-city (JP); Masamichi Yamagiwa, Yokkaichi-city (JP)

(73) Assignees: AUTONETWORKS TECHNOLOGIES, LTD., Mie (JP); SUMITOMO ELECTRIC INDUSTRIES, LTD., Osaka (JP); SUMITOMO WIRING SYSTEMS, LTD., Mie (JP)

(21) Appl. No.: 13/808,389

(22) PCT Filed: Jun. 1, 2011
(86) PCT No.: PCT/JP2011/062579

§ 371 Date: Jan. 4, 2013

(30) Foreign Application Priority Data
Aug. 9, 2010 (JP) 2010-178450

(51) Int. Cl. H01B 7/00; H01B 19/00

(52) U.S. Cl. CPC H01B 7/0045; H01B 19/00
USPC 174/135; 156/60; 156/185

(57) ABSTRACT

An electric wire protection structure has a structure in which a branch portion of an electric wire bundle is protected. In the electric wire protection structure, a protection portion covers the branch portion of the electric wire bundle, the protection portion being formed by heating and compressing a thermoplastic material in a state of covering at least the branch portion of the electric wire bundle.

### TECHNICAL FIELD

The present invention relates to a technology to protect a branch portion of an electric wire bundle.

### BACKGROUND ART

As a technology to protect a branch portion of an electric wire bundle, the branch portion of the electric wire bundle is sometimes housed inside a resin protector designed in advance.

Patent Literature 1 discloses a wire harness, which is formed by placing a flat circuit body between two covering bodies composed of a thermoplastic material and press-forming to adhere the covering bodies to the flat circuit body and weld the covering bodies.

### CITATION LIST

### Patent Literature

[Patent Literature 1] Japanese Patent Laid-Open Publication No. 2003-197038

### SUMMARY OF INVENTION

### Technical Problem

Such a protector above, however, has a uniform inner shape, which causes noise due to instability of the branch portion of the electric wire bundle housed inside and leads to a large outer shape. Patent Literature 1 merely discloses protection only for flat circuit bodies.

Accordingly, an object of the present invention is to protect a branch portion of an electric wire bundle using a thermoplastic material.

### Solution to Problem

A first aspect provides an electric wire protection structure protecting a branch portion of an electric wire bundle, including a protection portion covering the branch portion of the electric wire bundle, the protection portion being formed by heating and compressing a thermoplastic material in a state of covering at least the branch portion of the electric wire bundle.

A second aspect provides the electric wire protection structure according to the first aspect, in which the protection portion is formed by winding at least a portion of the thermoplastic material around at least a portion of the branch portion of the electric wire bundle and heating and compressing the thermoplastic material in a state of covering the branch portion of the electric wire bundle.

A third aspect provides the electric wire protection structure according to the first or second aspect, in which the protection portion is formed by winding the thermoplastic material having a long band shape around the branch portion of the electric wire bundle and heating and compressing the thermoplastic material in a state of covering the branch portion of the electric wire bundle.

A fourth aspect provides the electric wire protection structure according to the first or second aspect, in which the protection portion is formed by heating and compressing the thermoplastic material in a state of sandwiching and covering the branch portion of the electric wire bundle.

A fifth aspect provides the electric wire protection structure according to the first or second aspect, in which the protection portion is formed by winding the thermoplastic material having a cut around the branch portion of the electric wire bundle and heating and compressing the thermoplastic material in a state of covering the branch portion of the electric wire bundle.

A sixth aspect provides a method of producing an electric wire protection structure protecting a branch portion of an electric wire bundle, including (a) a process of covering at least the branch portion of the electric wire bundle by a thermoplastic material; and (b) a process of heating and compressing the thermoplastic material in a state of covering the branch portion of the electric wire bundle in the process (a).

A seventh aspect provides the method of producing the electric wire protection structure according to the sixth aspect, in which in the process (a), at least a portion of the thermoplastic material is wound around at least a portion of the branch portion of the electric wire bundle and the thermoplastic material covers the branch portion of the electric wire bundle.

An eighth aspect provides the method of producing the electric wire protection structure according to the sixth or seventh aspect, in which in the process (a), the thermoplastic material having a long band shape is wound around the branch portion of the electric wire bundle and covers the branch portion of the electric wire bundle.

A ninth aspect provides the method of producing the electric wire protection structure according to the sixth or seventh aspect, in which in the process (a), the thermoplastic material sandwiches and covers the branch portion of the electric wire bundle.

A tenth aspect provides the method of producing the electric wire protection structure according to the sixth or seventh aspect, in which in the process (a), the thermoplastic material having a cut is wound around the branch portion of the electric wire bundle and covers the branch portion of the electric wire bundle.

### Advantageous Effects of Invention

According to the electric wire protection structure of the first aspect, the protection portion covers the branch portion of the electric wire bundle, the protection portion being formed by heating and compressing the thermoplastic material in the state of covering the branch portion of the electric wire bundle. Thus, the thermoplastic material can protect the branch portion of the electric wire bundle.

According to the electric wire protection structure of the second aspect, the protection portion is formed by winding at least a portion of the thermoplastic material around at least a portion of the branch portion of the electric wire bundle and heating and compressing the thermoplastic material in the state of covering the branch portion of the electric wire bundle. This positions the electric wire bundle relative to the thermoplastic material at least in one direction, thus preventing the electric wire bundle from being displaced relative to the thermoplastic material.

According to the electric wire protection structure of the third aspect, the protection portion is formed by winding the thermoplastic material having a long band shape around the branch portion of the electric wire bundle and heating and compressing the thermoplastic material in the state of covering the branch portion of the electric wire bundle. Thus, the thermoplastic material can protect the branch portion of the electric wire bundle even in a case where a branch shape is more complex.

According to the electric wire protection structure of the fourth aspect, the protection portion is formed by heating and compressing the thermoplastic material in the state of sandwiching and covering the branch portion of the electric wire bundle. Thus, the thermoplastic material can protect the branch portion of the electric wire bundle in a simpler manner.

According to the electric wire protection structure of the fifth aspect, the protection portion is formed by winding the thermoplastic material having a cut around the branch portion of the electric wire bundle and heating and compressing the thermoplastic material in the state of covering the branch portion of the electric wire bundle. The thermoplastic material having a simple form can protect the branch portion of the electric wire bundle in a form fitted along an outer peripheral shape of the branch portion.

According to the method of producing the electric wire protection structure of the sixth aspect, the electric wire protection structure can be produced in which the thermoplastic material protects the branch portion of the electric wire bundle.

According to the method of producing the electric wire protection structure of the seventh aspect, at least a portion of the thermoplastic material is wound around at least a portion of the branch portion of the electric wire bundle. This positions the electric wire bundle relative to the thermoplastic material at least in one direction, thus preventing the electric wire bundle from being displaced relative to the thermoplastic material.

According to the method of producing the electric wire protection structure of the eighth aspect, the electric wire protection structure can be produced in which the thermoplastic material protects the branch portion of the electric wire bundle even in a case where a branch shape is more complex.

According to the method of producing the electric wire protection structure of the ninth aspect, the electric wire protection structure can be produced in which the thermoplastic material protects the branch portion of the electric wire bundle in a simpler manner.

According to the method of producing the electric wire protection structure of the tenth aspect, the electric wire protection structure can be produced in which the thermoplastic material having a simpler shape protects the branch portion of the electric wire bundle in a form fitted along an outer peripheral shape of the branch portion.

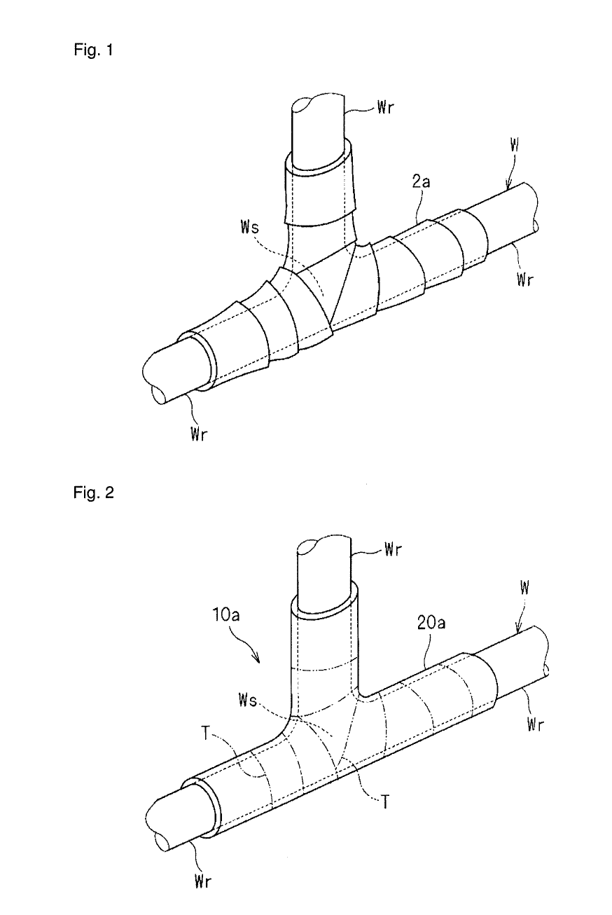

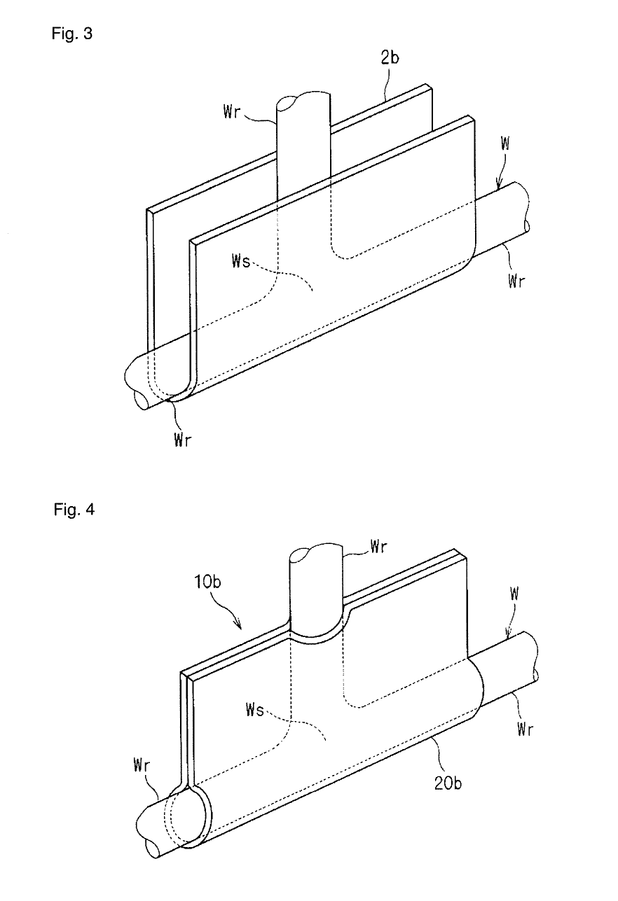

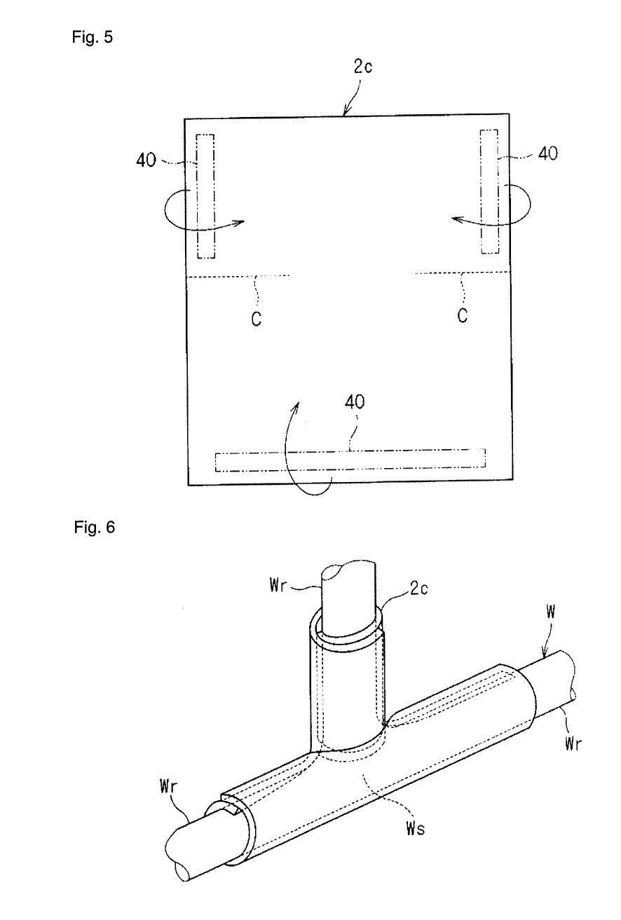

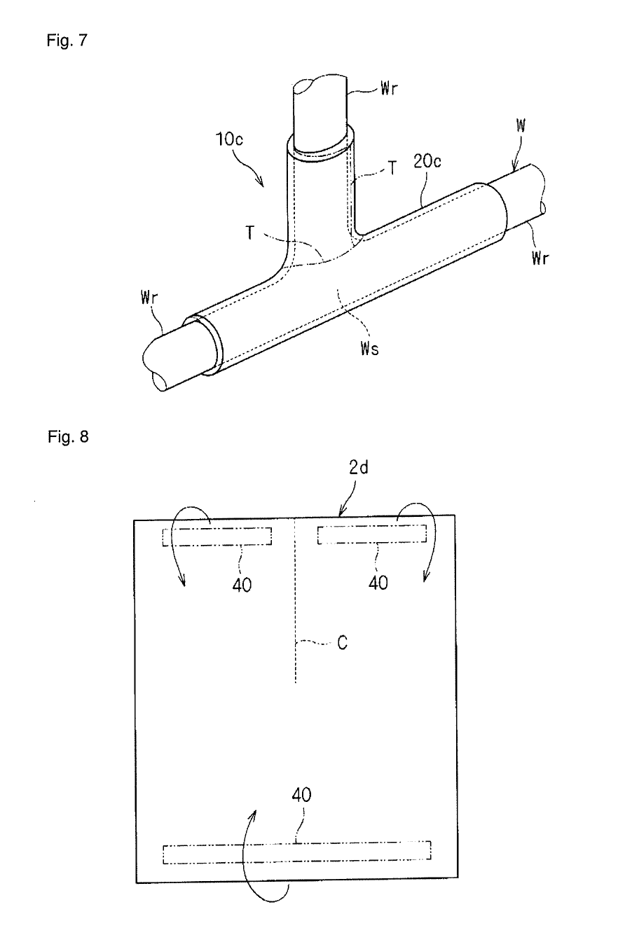

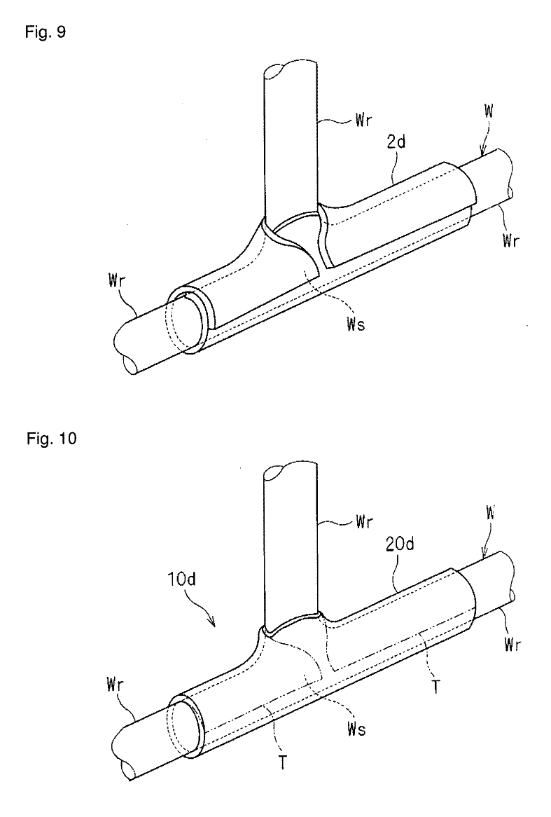

### BRIEF DESCRIPTION OF DRAWINGS

[FIG. 1] A view illustrating a state in which a nonwoven material covers an electric wire bundle according to a first embodiment.

[FIG. 2] A view of an electric wire protection structure according to the first embodiment.

[FIG. 3] A view illustrating a state in which a nonwoven material covers an electric wire bundle according to a second embodiment.

[FIG. 4] A view of an electric wire protection structure according to the second embodiment.

[FIG. 5] A view of a nonwoven material used in a third embodiment.

[FIG. 6] A view illustrating a state in which the nonwoven material covers an electric wire bundle according to the third embodiment.

[FIG. 7] A view of an electric wire protection structure according to the third embodiment.

[FIG. 8] A view of a nonwoven material used in a fourth embodiment.

[FIG. 9] A view illustrating a state in which the nonwoven material covers an electric wire bundle according to the fourth embodiment.

[FIG. 10] A view of an electric wire protection structure according to the fourth embodiment.

### DESCRIPTION OF EMBODIMENTS

An electric wire protection structure and a method of producing an electric wire protection structure according to embodiments are described. The present electric wire protection structure has a structure in which a thermoplastic material covers a branch portion of an electric wire bundle for protection and form maintenance.

An electric wire bundle is assumed to configure a wire harness routed in a vehicle and the like. The electric wire bundle is composed of a plurality of electric wires stacked adjacently in a radial direction (direction of plurality) to one another and bundled in substantially a circular or rectangular shape from a cross-sectional view. A branch portion of the electric wire bundle to be covered is a portion where electric wires extend in three directions, the portion having a shape in which one branch wire extends from a middle portion of a main wire or a shape in which an end portion of a main wire is split into two. The branch portion refers to an intersecting portion of the electric wire bundle. A linear portion extending therefrom is referred to as a branch wire. FIGS. 1 to 4, 6, 7, 9, and 10 each illustrate, as an example of a branch portion Ws of an electric wire bundle W, a state in which two branch wires Wr extend in substantially a linear shape through the branch portion Ws and one branch wire Wr extends from the branch portion Ws in substantially an orthogonal direction to the two branch wires Wr. In the drawings above, the branch wires Wr are each illustrated to have substantially the same diameter. The branch wires Wr, however, may have branch shapes having different diameters.

An electric wire protection structure 10a according to a first embodiment is first described (refer to FIG. 2). The electric wire protection structure 10a has a structure in which a protection portion 20a covers the branch portion Ws of the electric wire bundle W above. The protection portion 20a is formed by heating and pressuring (more specifically, hot-pressing) a thermoplastic material in a state of covering at least the branch portion Ws of the electric wire portion W.

Hot-pressing is a process in which a thermoplastic material, which is an object to be processed, is placed between molds and pressured in a state where the molds are heated to form a nonwoven material. More specifically, a pair of molds is preferably used, which has a mold surface to form the protection portion 20a corresponding to a branch shape of the electric wire bundle W. Specifically, a nonwoven material 2a which covers the electric wire bundle W is placed on one of the molds. While the pair of molds is heated, the other mold is moved closely relative to the mold to form the nonwoven material 2a. Thus, the electric wire protection structure 10a is produced in which the electric wire bundle W is covered by the protection portion 20a composed of the hardened thermoplastic material. The molds are not limited to a pair of molds, but may be molds divided into three or more.

The thermoplastic material is described below. The thermoplastic material is a material which is melted or softened partially or entirely by heating and is solidified by cooling. The thermoplastic material is formed or adhered while it is heated to be in a melted or softened state and is then cooled. Thus, the thermoplastic material can maintain a predetermined shape into which it is formed or adhered. A nonwoven material is used for description herein as an example of the thermoplastic material.

A nonwoven material capable of being hardened through a heating process can be used. Such a nonwoven material may include an elementary fiber and an adhesive resin (also referred to as a binder). The adhesive resin has a melting point lower than that of the elementary fiber. The nonwoven material is heated at a temperature lower than the melting point of the elementary fiber and higher than the melting point of the adhesive resin, and thereby the adhesive resin is melted and infiltrated into the elementary fiber. Thereafter, the temperature of the nonwoven material is lowered, and then the adhesive resin is solidified. Thus, the nonwoven material is heated and hardened so as to be maintained in a formed state at the time of heating. The nonwoven material is normally formed into a sheet shape (also referred to as nonwoven fabric) and is assumed to have a sheet shape in the description below.

Other than a resin fiber, various fibers capable of holding a fibrous state at the melting point of the adhesive resin may be used as the elementary fiber. Furthermore, a thermoplastic resin fiber, which has a melting point lower than the elementary fiber, may be used as the adhesive resin. An exemplary combination of the elementary fiber and the adhesive resin may include a resin fiber composed of PET (polyethylene terephthalate) as the elementary fiber and a copolymer resin composed of PET and PEI (polyethylene isophthalate) as the adhesive resin.

Specifically, the protection portion 20a is formed by hot-pressing the nonwoven material 2a, which is the thermoplastic material above, in a state where it covers at least the branch portion Ws of the electric wire bundle W. More specifically, at least a portion of the nonwoven material 2a is wound around at least a portion of the branch portion Ws of the electric wire bundle W, and the nonwoven material 2a is hot-pressed in the state of covering the branch portion Ws of the electric wire bundle W. That the nonwoven material 2a is wound around means that the nonwoven material 2a is bent along an outer peripheral surface of the electric wire bundle W. Preferably, the nonwoven material 2a is wound half around the electric wire bundle 2a. Thus, the branch portion Ws of the electric wire bundle W is covered by the protection portion 20a, which is a portion composed of the hardened nonwoven material 2a. In other words, the protection portion 20a protects the branch portion Ws of the electric wire bundle W from outside while maintaining a shape thereof so as to prevent from deformation. The protection portion 20a should cover at least the branch portion Ws of the electric wire bundle W, and may be formed so as to partially cover the branch wire Wr extending from the branch portion Ws of the electric wire bundle W.

In the electric wire protection structure 10a, the protection portion 20a is formed by winding the nonwoven material 2a having a long band shape around the branch portion Ws of the electric wire bundle W and hot-pressing the nonwoven material 2a in the state where it covers the branch portion Ws of the electric wire bundle W (refer to FIG. 2). Specifically, the long-band-shaped nonwoven material 2a is wound around the entire surface of the branch portion Ws of the electric wire bundle W. In the present embodiment, the nonwoven material 2a is wound around portions adjacent to the branch portion Ws of the branch portion Ws and the three branch wires Wr, which are portions to be protected in the electric wire bundle W, and is hot-pressed in the state where the nonwoven material 2a covers the branch portion Ws and each of the branch wires Wr.

The long-band-shaped nonwoven material 2a is wound around the electric wire bundle W as described below (refer to FIG. 1). Specifically, the long-band-shaped nonwoven material 2a is wound around the branch portion Ws and the three branch wires Wr of the electric wire bundle W while being shifted and overlapped such that the portion and wires are not exposed. To wind around the branch portion Ws of the electric wire bundle W, the long-band-shaped nonwoven material 2a is preferably wound around as being hooked around each split portion of the branch wires Wr (including the branch portion Ws between any branch wires Wr positioned on substantially a linear line). The nonwoven material 2a is wound as being cross-coupled herein. The nonwoven material 2a is preferably wound around each portion of the electric wire bundle W in two or more layers on the outer periphery. A double-sided adhesive tape is preferably attached to the long-band-shaped nonwoven material 2a on a surface directed to the inner periphery when winding to retain winding.

In the state where the nonwoven material 2a covers the branch portion Ws and the three branch wires Wr of the electric wire bundle W as described above, the nonwoven material 2a is hot-pressed to form the electric wire protection structure 10a. The nonwoven material 2a herein is adhered in the overlapped portions with melted adhesive resin and is held in a wound shape.

The nonwoven material 2a is hardened in the state where the long-band-shaped nonwoven material 2a is shifted and overlapped on the outer periphery of the electric wire bundle W. Thus, linear traces T of a side end portion of the long-band-shaped nonwoven material 2a are left in the surface of the protection portion 20a. The linear traces T are indicated with dashed-two dotted lines in FIG. 2.

An electric wire protection structure 10b according to a second embodiment is then described (refer to FIG. 4). Descriptions of components similar to those described with the electric wire protection structure 10a according to the first embodiment are omitted.

In the electric wire protection structure 10b according to the second embodiment, a protection portion 20b is formed by hot-pressing a nonwoven material 2b in a state of covering the branch portion Ws of the electric wire bundle W in between.

In the present embodiment, the nonwoven material 2b also covers portions adjacent to the branch portion Ws in between of the branch portion Ws and the three branch wires Wr of the electric wire bundle W (refer to FIG. 3). Specifically, the nonwoven material 2b is bent along outer peripheral surfaces of the branch portion Ws and two branch wires Wr of the electric wire bundle W and is wound around half or more of the portion and wires. The nonwoven material 2b has substantially a rectangular sheet shape and has a plane area large enough to cover in between the branch portion Ws and the three branch wires Wr of the electric wire bundle W. More specifically, the nonwoven material 2b is bent to align one end portion and another end portion, and thus covers the electric wire bundle W therebetween.

In the state where the nonwoven material 2b covers the branch portion Ws and the three branch wires Wr of the electric wire bundle W as described above, the nonwoven material 2b is hot-pressed to form the electric wire protection structure 10b. The nonwoven material 2b herein is adhered with melted adhesive resin in portions extending to sides of the electric wire bundle W in a state of having the electric wire bundle W in between and is held in a shape in which the electric wire bundle W is provided in between.

The nonwoven material 2b is formed as being hardened covering the outer periphery of the electric wire bundle W and being hardened in a shape in which the extra portions on the sides of the electric wire bundle W extend in a plate shape.

Electric wire protection structures 10c and 10d according to a third and fourth embodiments are then described (refer to FIGS. 7 and 10). Descriptions of components similar to those described with the electric wire protection structure 10a according to the first embodiment are omitted.

In the electric wire protection structures 10c and 10d according to the third and fourth embodiments, protection portions 20c and 20d are formed by winding nonwoven materials 2c and 2d having cuts C around the branch portions Ws of the electric wire bundles W and hot-pressing the nonwoven materials 2c and 2d in a state of covering the branch portions Ws of the electric wire bundles W. The cuts C are provided to allow the nonwoven materials 2c and 2d to be wound around the branch portions Ws such that portions divided by the cuts C overlap other portions on the outer peripheries of the branch portions Ws. In the present embodiments, portions of the nonwoven materials 2c and 2d that include the portions divided by the cuts C are wound around the branch portions Ws or the branch wires Wr of the electric wire bundles W and are hot-pressed and formed in a partially overlapped state.

In the electric wire protection structure 10c according to the third embodiment, the protection portion 20c is formed by hot-pressing the nonwoven material 2c having substantially a rectangular sheet shape and provided with the cuts C in the state of being wound around the branch portion Ws of the electric wire bundle W (refer to FIG. 7), the cuts C being provided from middle portions of both sides toward the center (sides opposing in a left/right direction in FIG. 5) and each having a length shorter than a half of a dimension between the opposing sides.

In the present embodiment, the nonwoven material 2c is wound around so as to cover portions adjacent to the branch portion Ws of the branch portion Ws and the three branch wires Wr of the electric wire bundle W (refer to FIG. 6). The nonwoven material 2c has dimensions such that, in a direction connecting one end portion (upper end portion in FIG. 5) and another end portion (lower end portion in FIG. 5), the one end portion of the cuts C covers a protected portion of one branch wire Wr in an extending direction and the other end portion of the cuts C covers two branch wires Wr in a circumferential direction (end portions overlap). The nonwoven material 2c has a width dimension between the side end portions such that the one end portion of the cuts C covers the one branch wire Wr in the circumferential direction (end portions overlap) and covers the protected portions of the two branch wires Wr in the extending direction. A double-sided adhesive tape 40 is preferably attached to the nonwoven material 2c on a surface directed to the inner periphery to retain winding. As indicated with dashed-two dotted lines in FIG. 5, for example, the double-sided tape 40 is preferably attached to both side end portions on the one end side from the cuts C and the other end portion.

The nonwoven material 2c is wound around the electric wire bundle W as described below. First, the one end portion of the nonwoven material 2c is mainly wound around the one branch wire Wr of the electric wire bundle W. More specifically, side end portions of the one end portion from the cuts C, which is a free end portion relative to the other end portion with the cuts C provided, are brought proximate to each other to wrap around the one branch wire Wr above and overlap each other. In this state, an end edge portion of the one end side of the cuts C of the nonwoven material 2c also partially covers the branch portion Ws adjacent to the one branch wire Wr.

Subsequently, the other end portion from the cuts C of the nonwoven material 2c is wound around the branch portion Ws and portions adjacent to the branch portion Ws of the other two branch wires Wr. More specifically, the other end portion of the nonwoven material 2c is wound around such that the other end portion is brought proximate to an end edge portion of the other end side of the cuts C. Then, the other end portion of the nonwoven material 2c is overlapped on the end edge portion of the one end side of the cuts C wound around the one branch wire Wr and on the end edge portion of the other end side of the cuts C to be wound around the branch portion Ws and the two branch wires Wr.

In the state where the nonwoven material 2c covers the branch portion Ws and the three branch wires Wr of the electric wire bundle W as described above, the nonwoven material 2c is hot-pressed to form the electric wire protection structure 10c. The nonwoven material 2c herein is adhered in the overlapped portions with melted adhesive resin and is held in a wound shape.

The one end portion from the cuts C of the nonwoven material 2c is hardened in the state where it covers the one branch wire Wr and a portion of the branch portion Ws and the both side end portions overlap. The other end portion from the cuts C of the nonwoven material 2c is hardened in the state where it covers the branch portion Ws and the other two branch wires Wr and overlaps the end edge portion of the other end side of the cuts C of the nonwoven material 2c and the end edge portion of the one end side that overlaps on the outer periphery of the branch portion Ws. Thus, in the protection portion 20c, linear traces T of the sides of the nonwoven material 2c are left in the surface of the portion that covers the one branch wire Wr and linear traces T of the other side of the nonwoven material 2c are left in the surface of the portion that covers the branch portion Ws and the other two branch wires Wr. The linear traces T are indicated with dashed-two dotted lines in FIG. 7.

FIG. 6 illustrates an example where the one end portion of the nonwoven material 2c is wound around the electric wire bundle W, and then the other end portion is overlapped on the outer periphery relative to the end edge portion of the one end side and the end edge portion of the other end side of the cuts C. The other end portion may be wound around such that the end edge portion of the other end side of the cuts C of the nonwoven material 2c overlaps the outer periphery of the other end portion, and then the one end portion may be wound around such that the end edge portion of the one end side of the cuts C overlaps the outer periphery of the other end portion.

In the electric wire protection structure 10d according to the fourth embodiment, the protection portion 20d is formed by hot-pressing the nonwoven material 2d having substantially a rectangular sheet shape and provided with the cut C in the state of being wound around the branch portion Ws of the electric wire bundle W (refer to FIG. 10), the cut C being provided from substantially a central portion of one side (upper side in FIG. 8) toward another end side (lower side in FIG. 8).

In the present embodiment, the nonwoven material 2d is wound around so as to cover portions adjacent to the branch portion Ws of the branch portion Ws and the two branch wires Wr of the electric wire bundle W (refer to FIG. 9). The nonwoven material 2d has dimensions such that, in a direction connecting one end portion and another end portion, the one other end portion from the cut C covers the two branch wires Wr in the circumferential direction and both side portions of the cut C are wound around with one branch wire Wr therebetween to overlap an end portion of the other end portion. The nonwoven material 2d has a width dimension between the sides (sides opposing in the left/right direction in FIG. 8) so as to cover the protected portion of the two branch wires Wr in an extending direction. A double-sided adhesive tape 40 is preferably attached to the nonwoven material 2d having the cut C on a surface directed to the inner periphery to retain winding. As indicated with dashed-two dotted lines in FIG. 8, for example, the double-sided tape 40 is preferably attached to the one end portion and the other end portion.

The nonwoven material 2d is wound around the electric wire bundle W as described below. Specifically, the other end portion from the cut C of the nonwoven material 2d is wound around the branch portion Ws and the two branch wires Wr of the electric wire bundle W. Furthermore, portions of the one end side divided by the cut C are wound around the two branch wires Wr and a portion of the branch portion Ws adjacent thereto with the other one branch wire Wr therebetween. Then, each of the one end portions of the nonwoven material 2d is overlapped on the other end portion. Specifically, the other end portion and each of the divided one end portions of the nonwoven material 2d are overlapped on the portion of the branch portion Ws adjacent to the two branch wires Wr.

FIG. 9 illustrates an example where each of the one end portions of the nonwoven material 2d is overlapped on the outer periphery relative to the other end portion wound around the electric wire bundle W in advance. Each of the one end side portions may be wound around, and then the other end portion may be overlapped on the outer periphery relative to each of the one end portions.

In the state where the nonwoven material 2d covers the branch portion Ws and the two branch wires Wr of the electric wire bundle W as described above, the nonwoven material 2d is hot-pressed to form the electric wire protection structure 10d. The nonwoven material 2d herein is adhered in the overlapped portions with melted adhesive resin and is held in a wound shape.

The nonwoven material 2d is hardened in the state where it covers the two branch wires Wr and a portion of the branch portion Ws adjacent thereto and the other end portion and each of the one end portions divided by the cut C overlap. Thus, in the protection portion 20d, linear traces T of the other side and end edge portions of the cut C of the nonwoven material 2d are left in the surface of the portion that covers the two respective branch wire Wr. The linear traces T are indicated with dashed-two dotted lines in FIG. 10.

Other than the above-described branch portion Ws of the electric wire bundle W, an electric wire protection structure that protects a branch portion Ws where three branch wires Wr branch out at different angles can be produced in a similar manner to production of the above electric wire protection structures 10a to 10d.

With respect to the electric wire protection structures 10a, 10c, and 10d, the structures are described where the protection portions 20a, 20c, and 20d protect the portions adjacent to the branch portions Ws in the two or three branch wires Wr, in addition to the branch portions Ws of the electric wire bundles W. A protection portion may have a structure that protects only the branch portion Ws.

Specifically, the electric wire protection structure 10a according to the first embodiment may be produced by hooking the long-band-shaped nonwoven material 2a around each split portion of the branch wires Wr to wind only around the branch portion Ws of the electric wire bundle W. The electric wire protection structure 10b according to the third embodiment may be produced, using a nonwoven material having a reduced one end portion of the cuts C and width dimension between the sides in accordance with the branch portion Ws, by winding the other end portion of the cuts C only around the branch portion Ws of the electric wire bundle W and winding the side end portions of the one end portion around to overlap the other end portion on the outer periphery of the branch portion Ws. The electric wire protection structure 10d according to the fourth embodiment may be produced, using a nonwoven material having a reduced width dimension between the sides in accordance with the branch portion Ws, by winding the other end portion of the nonwoven material only around the branch portion Ws of the electric wire bundle W and winding the both side portions of the cut C around with one branch wire Wr therebetween to overlap the other end portion on the outer periphery of the branch portion Ws.

In addition, according to the methods of producing the electric wire protection structures 10a and 10b of the first and second embodiments, an electric wire protection structure that protects a branch portion where four or more branch wires extend can also be produced.

According to the electric wire protection structures 10a to 10d, the branch portions Ws of the electric wire bundles W can be protected by the nonwoven materials 2a to 2d. In the structures where the branch wires Wr, in addition to the branch portions Ws of the electric wire bundles W, are covered by the nonwoven materials 2a to 2d, heated molds can be prevented from directly facing the electric wire bundles W when hot-pressing the nonwoven materials 2a to 2d, thus preventing burning of the electric wire bundles W.

The protection portions 20a to 20d are formed by winding the nonwoven materials 2a to 2d at least partially wound around the branch portions Ws of the electric wire bundles W and hot-pressing the nonwoven materials 2a to 2d in the state of covering the branch portions Ws of the electric wire bundles W. Accordingly, the electric wire bundles W are positioned at least on one side relative to the nonwoven materials 2a to 2d, thus preventing displacement of the electric wire bundles W relative to the nonwoven materials 2a to 2d (protection portion 20a to 20d).

According to the electric wire protection structure 10a and the method of producing the same according to the first embodiment, in particular, the protection portion 20a is formed by winding the long-band-shaped nonwoven material 2a around the branch portion Ws of the electric wire bundle W and heating and compressing the nonwoven material 2a in the state of covering the branch portion Ws of the electric wire bundle W. This increases flexibility in winding the nonwoven material 2a, thus ensuring further to cover the protected portion of the electric wire bundle W even in a case of a complex shape. Hot-pressing the nonwoven material 2a in the state of covering the electric wire bundle W protects and maintains the shape of the portion adjacent to the branch portion Ws of the branch portion Ws and the three branch wires Wr of the electric wire bundle W in a shape fitted along an outer peripheral shape of the electric wire bundle W even in a case where a branch shape is more complex.

According to the electric wire protection structure 10b and the method of producing the same according to the second embodiment, the protected portion of the electric wire bundle W is simply sandwiched by the nonwoven material 2b so as to be covered. Thus, the nonwoven material 2b can protect and maintain the shape of the portion adjacent to the branch portion Ws of the branch portion Ws and the three branch wires Wr of the electric wire bundle W in a simpler manner.

According to the electric wire protection structure 10c and the method of producing the same according to the third embodiment, the sheet-shaped nonwoven material 2c provided with two cuts C is used to readily wind around and cover the branch portion Ws and the three branch wires Wr of the electric wire bundle W. This allows hot-pressing in the shape fitted along the outer peripheral shape of the electric wire bundle W and protects and maintains the shape of the portion adjacent to the branch portion Ws of the branch portion Ws and the three branch wires Wr of the electric wire bundle W in the shape fitted along the outer peripheral shape of the electric wire bundle W.

According to the electric wire protection structure 10d and the method of producing the same according to the fourth embodiment, the nonwoven material 2c having a simpler shape provided with only one cut C is used to readily wind around and cover the branch portion Ws and the two branch wires Wr of the electric wire bundle W. This allows hot-pressing in the shape fitted along the outer periphery of the electric wire bundle W and protects and maintains the shape of the portion adjacent to the branch portion Ws of the branch portion Ws and the two branch wires Wr of the electric wire bundle W in the shape fitted along the outer peripheral shape of the electric wire bundle W.

The electric wire protection structures 10a to 10d and the methods of producing the same are described in detail above. The descriptions above, however, are presented merely as examples in all aspects and the present invention is not limited thereto. It is construed that countless modifications not illustrated could be assumed without deviating from the scope of the present invention.

### REFERENCE SIGNS LIST

2a, 2b, 2c, 2d: Nonwoven material

10a, 10b, 10c, 10d: Electric wire protection structure

20a, 20b, 20c, 20d: Protection portion

C: Cut

W: Electric wire bundle

Ws: Branch portion

1. An electric wire protection structure protecting a branch portion of an electric wire bundle, comprising a protection portion covering the branch portion of the electric wire bundle, the protection portion being formed by heating and compressing a thermoplastic material covering at least the branch portion of the electric wire bundle.

2. The electric wire protection structure according to claim 1, wherein the protection portion is formed by winding at least a portion of the thermoplastic material around at least a portion of the branch portion of the electric wire bundle and heating and compressing the thermoplastic material covering the branch portion of the electric wire bundle.

3. The electric wire protection structure according to claim 1, wherein the protection portion is formed by winding the thermoplastic material having a long band shape around the branch portion of the electric wire bundle and heating and compressing the thermoplastic material covering the branch portion of the electric wire bundle.

4. The electric wire protection structure according to claim 1, wherein the protection portion is formed by heating and compressing the thermoplastic material sandwiching and covering the branch portion of the electric wire bundle.

5. The electric wire protection structure according to claim 1, wherein the protection portion is formed by winding the thermoplastic material having a cut around the branch portion of the electric wire bundle and heating and compressing the thermoplastic material covering the branch portion of the electric wire bundle.

6. A method of producing an electric wire protection structure protecting a branch portion of an electric wire bundle, comprising:
(a) covering at least the branch portion of the electric wire bundle with a thermoplastic material; and
(b) heating and compressing the thermoplastic material covering the branch portion of the electric wire bundle.

7. The method of producing the electric wire protection structure according to claim 6, wherein at least a portion of the thermoplastic material is wound around at least a portion of the branch portion of the electric wire bundle and covers the branch portion of the electric wire bundle.

8. The method of producing the electric wire protection structure according to claim 6, wherein the thermoplastic material having a long band shape is wound around the branch portion of the electric wire bundle and covers the branch portion of the electric wire bundle.

9. The method of producing the electric wire protection structure according to claim 6, wherein the thermoplastic material sandwiches and covers the branch portion of the electric wire bundle.

10. The method of producing the electric wire protection structure according to claim 6, wherein the thermoplastic material having a cut is wound around the branch portion of the electric wire bundle and covers the branch portion of the electric wire bundle.
